(19) United States
(12) Patent Application Publication
(10) Pub. No.: US 2009/0027422 A1
(43) Pub. Date: Jan. 29, 2009

(54) Image brightness control and compensation device for field emission display

(75) Inventors: Chung-Ming Cheng, Taipei County (TW); Tsung-Hsiang Huang, Changhua County (TW)

Correspondence Address: Joe McKinney Muncy, PO Box 1364, Fairfax, VA, 22038-1364, US

(73) Assignee: PRINCETON TECHNOLOGY CORPORATION

(21) Appl. No.: 11/907,684

(22) Filed: Oct. 16, 2007

(30) Foreign Application Priority Data
Jul. 24, 2007 (TW) 096212084

(51) Int. Cl. G09G 5/10

(52) U.S. Cl. 345/690

(57) ABSTRACT

An image adjusting device for adjusting brightness of an image signal is disclosed. The image adjusting device comprises a converting module and a processing module. The converting module is configured to convert an input image to an image signal. The processing module is coupled to the converting module and configured to adjust the image signal to generate an output signal according to a predetermined method, and the processing module further comprises a determining module, an adjusting module and a compensating module. The determining determines the brightness of the image signal to generate a determining signal. The adjusting module generates an adjusting signal according to the determining signal and a predetermined adjusting value. The compensating module adjusts the image signal to generate the output signal according to the adjusting signal.

### BACKGROUND OF THE INVENTION

1. Field of the Invention

The invention relates to image adjusting devices, and more particularly relates to image adjusting devices for adjusting image brightness.

2. Description of the Related Art

Similar to standard cathode ray tubes (CRTs), a field emission display (FED) radiates by irradiating high-energy electrons on image elements (pixels) of a screen. Then, the electrons are converted into visible light by the excited property. A main difference between FEDs and conventional CRTs is that FEDs scan chromatic elements of each pixel by fixed electron beams, while CRTs scan a raster figure of a screen by one or three electron beams. When comparing required distance between a screen and a scanned electron beam, FED requirements are much less than conventional CRT requirements. In addition, the power consumed for FEDs is far less than CRTs. The aforementioned conditions make FEDs suitable for portable electronic products such as notebook computers, mobile phones and PDAs.

General FED systems are provided with the ability for users to adjust brightness. However, image contents become obscure when brightness of an FED system is decreased to darker images. In this example, users will not able to see the contents of the image when decreased brightness surpasses a limit causing inconvenience to users. Thus, for higher quality advanced audio and video display systems, it is an important issue to overcome obscure image contents while using low brightness to increase display image quality

Therefore, providing an image adjusting device to adjust the brightness of a display image so that low brightness images can be viewed, is needed for increasing image quality.

### BRIEF SUMMARY OF THE INVENTION

A detailed description is given in the following embodiments with reference to the accompanying drawings.

An image adjusting device for adjusting brightness of an image signal is disclosed to solve the aforementioned problems. The image adjusting device comprises a converting module and a processing module. The converting module is configured to convert an input image to an image signal. The processing module is coupled to the converting module and configured to adjust the image signal to generate an output signal according to a predetermined method, and the processing module further comprises a determining module, an adjusting module and a compensating module. The determining module is configured to determine whether the brightness of the image signal is in a predetermined range to generate a determining signal. The adjusting module is coupled to the determining module, configured to generate an adjusting signal according to the determining signal and a predetermined adjusting value. The compensating module is coupled to the adjusting module, configured to adjust the image signal to generate the output signal according to the adjusting signal. In addition, the image adjusting device further comprises an output module and a display module. The output module is coupled to the processing module and configured to generate an output image according to the image signal or the output signal. The display module is coupled to the output module, and is configured to display the output image.

### BRIEF DESCRIPTION OF THE DRAWINGS

The invention can be more fully understood by reading the subsequent detailed description and examples with references made to the accompanying drawings, wherein:

FIG. 1 is a diagram illustrating an image adjusting device in an embodiment of the invention; and

FIG.2 is a diagram illustrating a processing module in the image adjusting device in an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

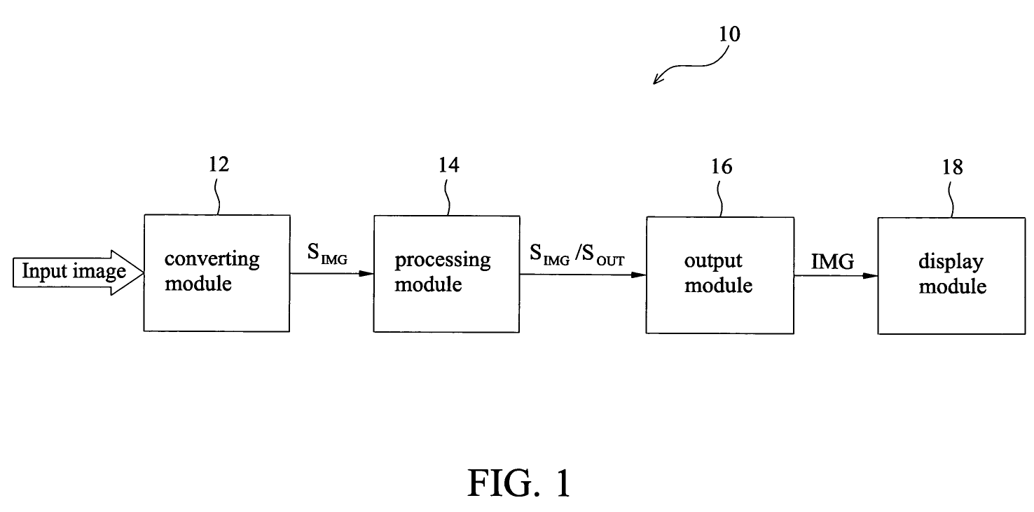

Referring to FIG. 1, FIG. 1 is a diagram illustrating the image adjusting device in an embodiment of the invention. An image adjusting device 10 is disclosed. Image adjusting device 10 comprises a converting module 12 and a processing module 14. Converting module 12 is configured to convert an input image to an image signal S_{IMG}, wherein converting module 12 converts the input image to the image signal S_{IMG} with a specific image format. In an embodiment of the invention, converting module 12 converts the input image to the image signal S_{IMG} with an RGB image format. Processing module 14 coupled to converting module 12 adjusts the image signal S_{IMG} to generate an output signal S_{OUT} according to a predetermined method, wherein processing module 14 adjusts brightness of the image signal S_{IMG}.

In an embodiment of the invention, the predetermined method determines whether the brightness of the image signal S_{IMG} is in a predetermined range. Processing module 14 adjusts the image signal S_{IMG} to generate the output signal S_{OUT} according to a predetermined adjusting value when the brightness of the image signal S_{IMG} is in the predetermined range. Processing module 14 outputs the image signal S_{IMG} directly when the brightness of the image signal S_{IMG} is not in the predetermined range. In an embodiment of the invention, the predetermined range is referred to as brightness of the image signal S_{IMG} below 20%. Specifically, the brightness of the image signal S_{IMG} is determined to be of low brightness when the brightness of the image signal S_{IMG} displayed on the screen is below 20%. Consequently, the image signal S_{IMG} is adjusted by processing module 14. The predetermined range may be set manually according to user requirements, and is not limited to the examples in the disclosed embodiments.

Image adjusting device 10 further comprises an output module 16 and a display module 18. Output module 16 coupled to processing module 14 generates an output image IMG according to the image signal S_{IMG} or the output signal S_{OUT}. Display module 18 coupled to output module 16 displays the output image IMG. In an embodiment of the invention, display module 18 is a field emission display (FED).

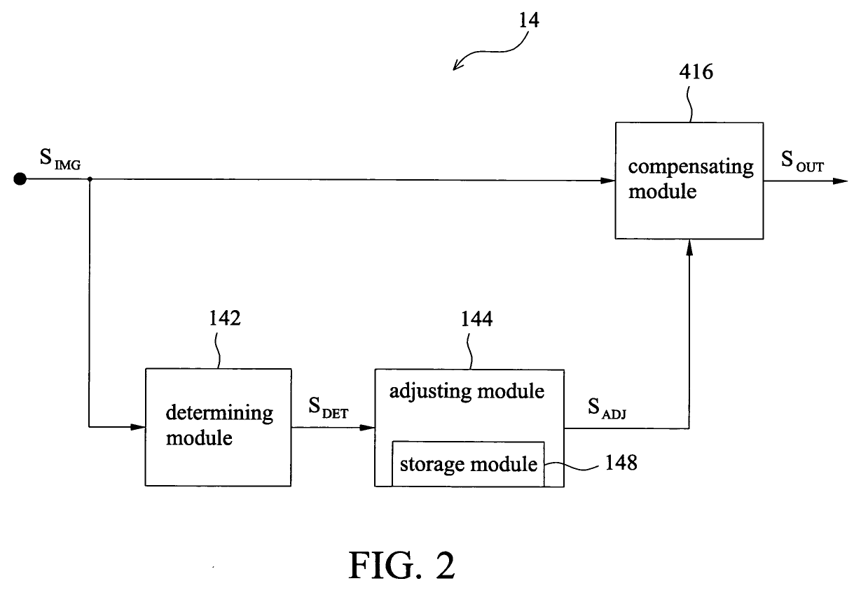

Referring to FIG. 2, FIG. 2 is a diagram illustrating the processing module in the image adjusting device in an embodiment of the invention. In FIG. 2, processing module 14 comprises a determining module 142, an adjusting module 144 and a compensating module 146. Determining module 142 is configured to determine whether the image signal S_{IMG} is in the predetermined range to generate a determining signal S_{DET}. Adjusting module 144 coupled to determining module 142 generates an adjusting signal S_{ADJ} according to the determining signal S_{DET} and the predetermined adjusting value. Compensating module 146 coupled to adjusting module 144 adjusts the image signal S_{IMG} to generate the output signal S_{OUT} according to the adjusting signal S_{ADJ}.

In addition, the adjusting module 144 further comprises a storage module 148 configured to store a mapping table (not shown). The mapping table stores a plurality of predetermined ranges and a plurality of adjusting values, wherein each of the predetermined ranges correspond to one of the adjusting values. Determining module 142 determines whether the image signal S_{IMG} is in one of the predetermined ranges. Adjusting module 144 generates the adjusting signal S_{ADJ} according to the adjusting value corresponding to the predetermined range determined by determining module 142.

In the embodiments of the invention, images of the output image adjusted and generated by the disclosed image adjusting device are displayed clearly on displays under low brightness. Thus, the ability for displays to display images is increased, thus increasing image quality.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image adjusting device for adjusting brightness of an image signal, comprising:
a converting module configured to convert an input image to the image signal; and
a processing module coupled to the converting module and configured to adjust the image signal to generate an output signal according to a predetermined method, wherein the processing module comprises:
a determining module configured to determine whether the brightness of the image signal is in a predetermined range to generate a determining signal;
an adjusting module coupled to the determining module, configured to generate an adjusting signal according to the determining signal and a predetermined adjusting value; and
a compensating module coupled to the adjusting module, configured to adjust the image signal to generate the output signal according to the adjusting signal.

2. The image adjusting device as claimed in claim 1, wherein the converting module converts the input image to the image signal with a specific image format.

3. The image adjusting device as claimed in claim 1, wherein the specific image format is an RGB image format.

4. The image adjusting device as claimed in claim 1, wherein the predetermined method determines whether the brightness of the image signal is in the predetermined range, the processing module adjusts the image signal to generate the output signal according to the predetermined adjusting value when the brightness of the image signal is in the predetermined range, and the processing module outputs the image signal directly when the brightness of the image signal is not in the predetermined range.

5. The image adjusting device as claimed in claim 4, wherein the predetermined range is referred to the brightness of the image signal below 20%.

6. The image adjusting device as claimed in claim 4, further comprising:
an output module coupled to the processing module, configured to generate an output image according to the image signal or the output signal.

7. The image adjusting device as claimed in claim 6, further comprising:
a display module coupled to the output module 16, configured to display the output image.

8. The image adjusting device as claimed in claim 7, wherein the display module is a field emission display (FED).

9. The image adjusting device as claimed in claim 1, wherein the adjusting module comprises:
a storage module configured to store a mapping table, wherein the mapping table comprises a plurality of predetermined ranges and a plurality of adjusting values.

10. The image adjusting device as claimed in claim 9, wherein each one of the predetermined ranges corresponds to one of the adjusting values.

11. The image adjusting device as claimed in claim 10, wherein the determining module determines whether the image signal is in one of the predetermined ranges.

12. The image adjusting device as claimed in claim 11, wherein the adjusting module generates the adjusting signal according to the adjusting value corresponding to the predetermined range determined by the determining module.
